(19) United States
(12) Patent Application Publication
(10) Pub. No.: US 2007/0271474 A1
(43) Pub. Date: Nov. 22, 2007

(54) System and method for disabling an electrical device

(75) Inventors: Nathaniel W. Kim, Raleigh, NC (US); Charles S. Lingafelt, Durham, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/436,351

(22) Filed: May 18, 2006

(51) Int. Cl. G06F 1/00

(52) U.S. Cl. 713/310

(57) ABSTRACT

The present invention provides a system and method for disabling an electrical device (e.g., that utilizes a data networking protocol such as 802.1X). Specifically, under the present invention, the electrical device is connected to a power socket of a power delivery network via a power bar. When disablement of a particular device is desired, the device is located by an authentication server (that communicates with the power bar over the power delivery network) using information stored in a devices information database. Once the particular device is located, an instruction to disable it is sent from the authentication server to a component, which then disables the device via the power bar.

### CROSS-REFERENCE TO RELATED APPLICATIONS

This application is related in some aspects to the commonly assigned and co-pending application identified by attorney docket number END920050064US1, assigned United States application serial number (to be provided), entitled “Method and System for Managing an Electrical Device Over a Power Delivery Network”, and filed (to be provided) the entire contents of which are herein incorporated by reference. This application is also related in some aspects to the commonly assigned and co-pending application identified by attorney docket number END920050143US1, assigned United States application serial number (to be provided), entitled “Method and System for Calibrating an Electrical Device”, and filed (to be provided) the entire contents of which are herein incorporated by reference.

### BACKGROUND OF THE INVENTION

1. Field of the Invention

The present invention generally provides a system and method for disabling an electrical device. Specifically, the present invention utilizes a power bar and other technology to enable and disable an electrical device.

2. Related Art

Within most organizations, there exists a need to identify and track physical re-locatable electrical devices/assets (e.g., medical equipment, computers, printers, photocopiers, etc.) that draw energy from the organization's power delivery network and to obtain device attribute information. In some cases, it is desirable that an electrical device no longer function when it is removed from the premises (e.g., theft deterrence). The ability to track and enable/disable such electrical devices could provide many advantages such as inventory management, device control, etc.

Unfortunately, no existing approach provides a solution for disabling an electrical device without requiring physical/manual location of the device. That is, under existing solutions, disablement of a single device requires an individual to physically locate the device, and then effect the disablement at the device itself.

In view of the foregoing, there exists a need to overcome one or more of the deficiencies in the prior art.

### SUMMARY OF THE INVENTION

In general, the present invention provides a system and method for disabling an electrical device (e.g., that utilizes a data networking protocol such as 802.1X). Specifically, under the present invention, the electrical device is connected to a power socket of a power delivery network via a power bar. When disablement of a particular device is desired, the device is located by an authentication server (e.g., that communicates with the power bar over the power delivery network) using information stored in a devices information database. Once the particular device is located, an instruction to disable it is sent from the authentication server to an authentication component, which then disables the device via the power bar.

In one embodiment, the authentication component is contained within the power bar. In another embodiment, the authentication component is contained within the power socket. In addition, the present invention can include an identification component for providing an identity of the electrical device (or the power bar), and a location component for providing a location of the electrical device (e.g., based on a location of the power bar or the power socket). The identification component is typically contained within the power bar, while the location component can be contained within the power bar or on the authentication server. In the case of the latter, the location of the electrical device (and power bar) is determined based on the location of the power socket using identifier information stored in a power socket location database.

As such, one aspect of the present invention provides a method and system for disabling an electrical device. Under this aspect, an instruction to disable the electrical device is received in an authentication component from an authentication server over a power delivery network. The electrical device is then disabled in response to the instruction via a power bar that is connected to a power socket of the power delivery network and the electrical device. Initially, the electrical device is authenticated and enabled via the power bar based on authentication information received on the authentication server from the authentication component. Such information can include the identity and location of the electrical device as provided by the identification component and the location component, respectively.

The present invention can be implemented using hardware, software, or a combination of hardware and software. As such, one or more features of the present invention could be implemented as a program product stored on a computer useable medium that comprises program code for performing the functions recited herein.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts electrical devices connected to a power delivery network according to the prior art.

FIG. 2 depicts 802.1X port-based authentication according to the prior art.

FIG. 3A depicts the enabling/disabling of an electrical device over a power delivery network via a power bar according to one embodiment of the present invention.

FIG. 3B depicts physical and logical views of the embodiment of FIG. 3A.

FIG. 4 depicts a diagram of an electrical device according to the embodiment of FIGS. 3A-B.

FIG. 5 depicts an operation flow diagram of the embodiment of FIGS. 3A-B and 4.

FIG. 6A depicts the enablement/disablement of an electrical device over a power delivery network via a power bar according to another embodiment of the present invention.

FIG. 6B depicts physical and logical views of the embodiment of FIG. 6A.

FIG. 7 depicts a diagram of an electrical device and a power socket according to the embodiment of FIGS. 6A-B.

FIG. 8 depicts an operation flow diagram of the embodiment of FIGS. 6A-B and 7.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

The invention applies to electrical devices that are connected to a power delivery network, such as an AC power delivery system, found in virtually all buildings. This invention enhances the power delivery network to dynamically identify an electrical device that is “plugged” into a power socket, identify the location of the electrical device and optionally control the application of power to the electrical device at the power socket. It should be understood in advance that the present invention (in either embodiment) can be implemented using computer hardware, computer software, or a combination of computer hardware and computer software.

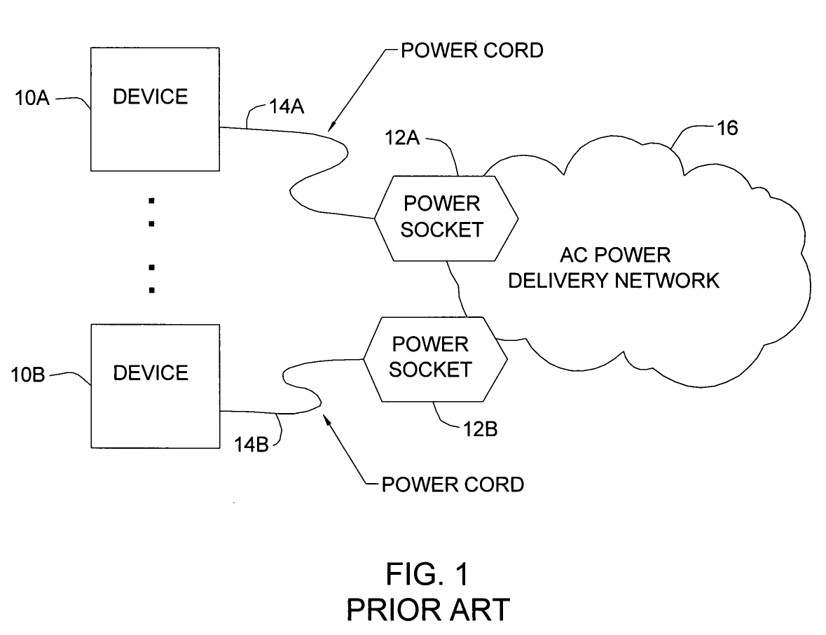

Referring now to FIG. 1, the connection of electric devices 10A-B to a power delivery network 16 according to the prior art is shown. As depicted, electric devices 10A-B connect to power delivery network 16 through power sockets 12A-B and power cords 14A-B. As will be further described below, the present invention will apply a data networking protocol to power delivery network 16 to provide management of electric devices 10A-B.

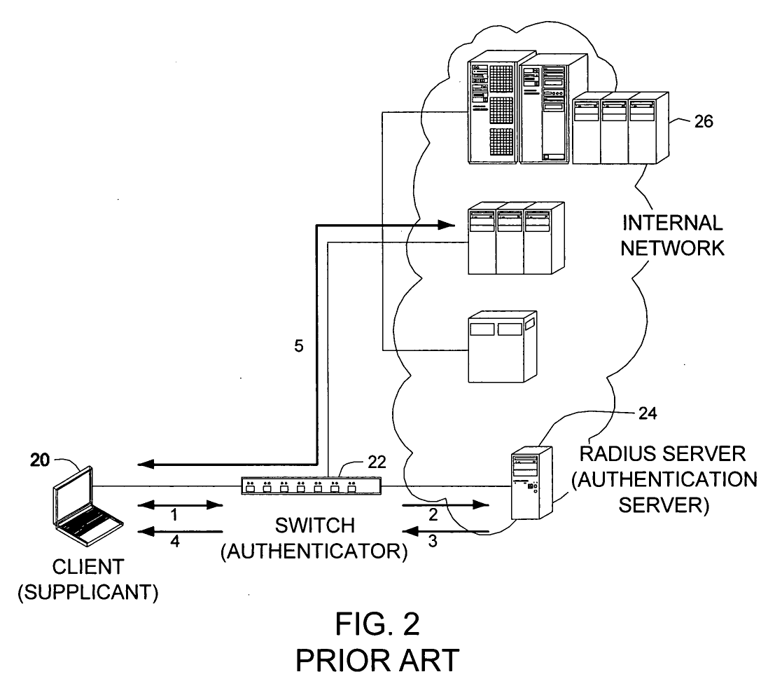

In a typical embodiment, the data networking protocol that is applied to power delivery network 16 is 802.1X, which is also known as port-based network access control. This networking protocol is currently an I.E.E.E. standard for identification and authentication of a device at an authentication (function) component that is typically a switch port. Referring to FIG. 2, an implementation of 802.1X for authentication a client device 20 (also referred to the art as “supplicant”) is shown. Specifically, in a Local Area Network (LAN) where 802.1X is enabled, the switch (authentication component) 22 challenges client device 20 for its identity to validate that it (or its user) is authorized to access data network 26. Switch 22 then sends the supplied information to an authentication server 24, which is typically a Remote Authentication Dial-In User Service (RADIUS) server, for actual authentication of the client device 20. The authentication server 24 responds to switch 22 with a response. If client device 20 is an authorized user, the switch puts the client's port in authenticated and forwarding state. Switch 22 then relays the authentication result to client device 20. Once client device 20 is authenticated and the port is in authorized state, client device 20 can access network 26 resources. If the authentication is not successful, switch 22 keeps the port closed and no network traffic will pass through. The present invention will apply these concepts to enable and disable electric devices through the power delivery network.

### Power Bar Embodiment A

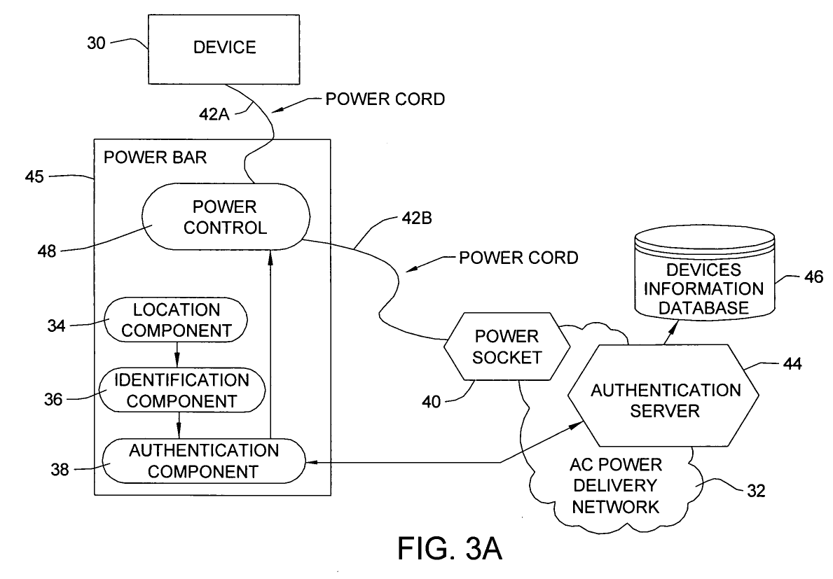

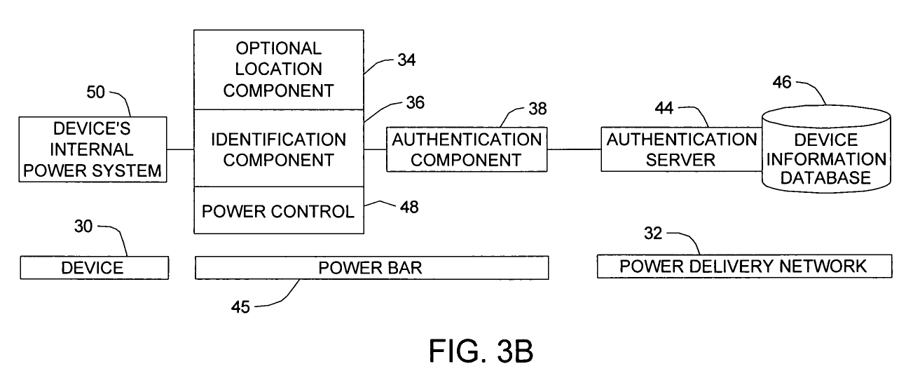

Referring to FIG. 3A, a first embodiment for enabling/disabling an electrical device 30 over (AC) power delivery network 32 using power bar 45 according to the present invention is shown. It should be understood that electrical device 30 could be any type of electrical device now known or later developed. Examples include non-data processing devices such as printers, medical equipment, etc., and data processing devices such as computers. In any event, the embodiment shown in FIG. 3A requires no modification to electrical device 30 or power delivery network 32, specifically in power socket 40. That is, the underlying functions or components of the present invention are implemented within power bar 45.

In any event, as shown, electrical device 30 connects to/is associated with power bar 45 via power cord 42A. Power bar 45 connects to/is associated with power delivery network 32 through power socket 40 via power cord 42B. The functions of each of the features shown in FIG. 3A will be set forth below:

(Optional) Location component/function 34—identifies the location of electrical device 30 based on the location of power bar 45. Specifically, because electrical device 30 is physically connected to power bar 45 via a power cord 42B of a known and finite length, the location of power bar 45 is also considered to be the location of electrical device 30. To this extent, location component 34 can include a Global Positioning System (GPS) unit, or incorporate triangulation methods based on known radio locations of power bar 45. Alternatively, location component 34 could be a manual input device such as a key pad, switch, etc. That is, a user could input the location (e.g., office “Y”) into a keypad or the like on power bar 45.

Identification component/function 36 (also referred to in the art as “supplicant function”)—Preferably, this is the 802.1X standard supplicant that provides and identity of electrical device 30 to the authentication component 38, e.g., per the 802.1X protocols. Under the present invention, identification component 36 identifies electrical device 30, and provides its location as provided by location component 34, to authentication component 38. As will be further described below, this identity of electrical device 30 can be obtained by identification component 36 from a variety of sources. In addition, it should be appreciated that a standard other than 802.1X could be implemented for identification component 36.

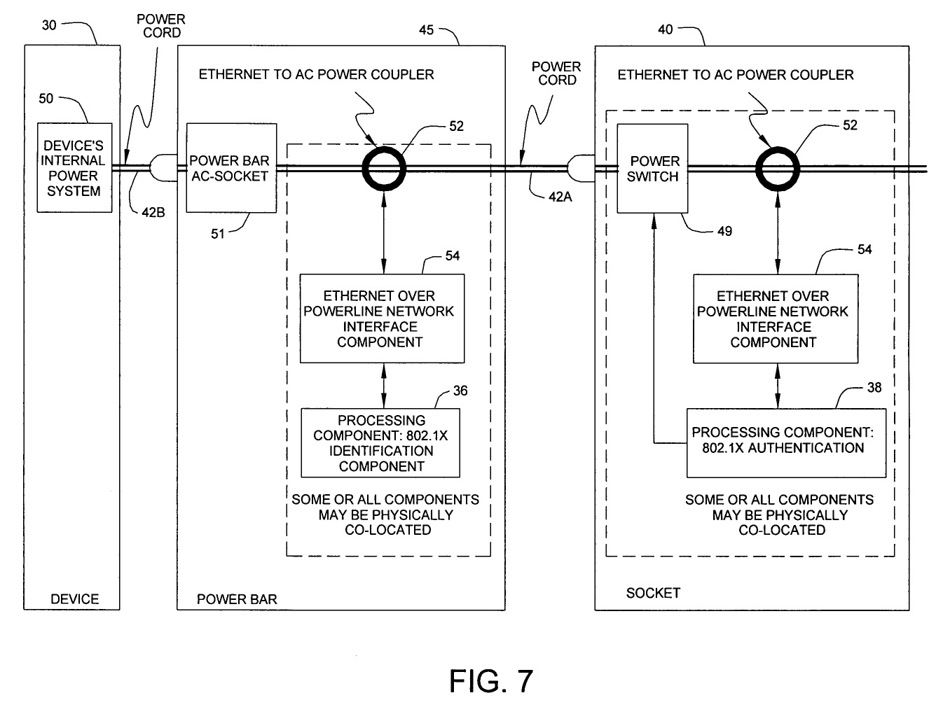

Power socket 40—in this embodiment, this a standard power socket that allows connection of power cord 42 into power delivery network 32. In another embodiment shown in FIG. 7, power socket 40 is built with a power switch that can be “shut off” by the authentication component 38 if electrical device 30 fails identification and authentication.

Authentication component/function 38—Preferably, this is the 802.1X standard authentication function that forwards the electrical device's 30 identity, credentials and access request to an authentication server 44, then acts on the commands from authentication server 44. It should be understood, however, that a standard other than 802.1X that performs authentication could suffice as well. In the embodiment of FIG. 3A, the command from authentication server 44 would cause electrical device 30 to connect to power delivery network 32. In the other embodiment to be discussed below, the authentication result could cause power socket 40 (FIG. 7) to “shut off” its power switch if the authentication fails. In this other embodiment, with successful identification and authentication of electrical device 30, power socket 40 would continue to supply power to electrical device 30.

Authentication server 44—Preferably, this is the 802.1X standard authentication server that, given the identity (and optionally credentials), which represent electrical device 30's (or power bar 45's) request for power, and determines if the device 30 should become energized. This decision is sent to the authentication component 38 for action. It should be understood, however, that a standard other than the 802.1X standard could be implemented for authentication server 44.

(AC) Power delivery network 32—this represents an AC power system (e.g., in a building) that distributes power. Access into this system is typically via 120 volt AC sockets. However this need not be the case and other alternatives could be implemented.

Devices information DB 46—the database function that contains the result of the authentication server 44's process and the association of electrical device 30 with other information. This will generally yield a database with fields such as Device_ID, Device's_Power_Socket_Location, Time_Device_was_energized, Time_Device_{was}_de-energized, Device's_Power_Consumption, Device_Power_Priority, etc.

Referring to FIG. 3B, physical and logical views of the embodiment of FIG. 3A are shown. Specifically, as shown, electrical device 30 includes internal power system 50, and is connected to power bar 45. As further shown, power bar 45 includes optional location component 34, identification component 36, authentication component 38, and power control 48. Power delivery network 32 incorporates authentication server 44 and device information database 46 (and the power socket although not shown in FIG. 3B).

Under this embodiment, the functionality is primarily contained within power bar 45. As will be further described below, this allows electrical device 30 to be enabled/disabled from authentication server 44 by sending an appropriate command to authentication component 38 to engage/disengage power control/switch 48.

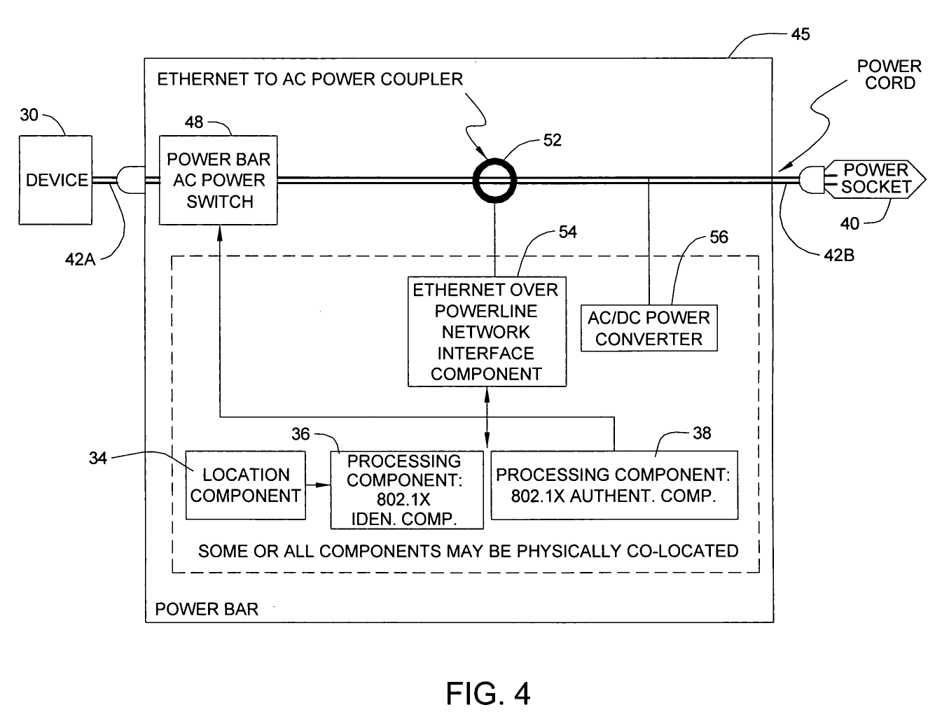

FIG. 4 depicts a more detailed diagram of electrical device 30 according to the embodiment of FIGS. 3A-B. As shown, electrical device 30 connects to power bar 45 via power cord 42A, while power bar 45 connects to power socket 40 via power cord 42B. The device includes an internal power system 50 (as shown in FIG. 3B) and is connected to power bar 45. As further shown, power bar 45 includes (optional) location component 34, identification component 36, authentication component 38, power control (AC power switch) 48, Ethernet to AC power coupler 52, Ethernet over power line network interface component 54, and AC/DC power converter 56. The features of power bar 45 are defined as follows:

Power control 48—The component, which under control of the 802.1X supplicant/device 30, connects the AC power from the power cord 42 to the device's internal power system 50. Multiple different physical components could be used (e.g., FETs, relays, digital or analog control signals to the device's AC/DC power supply, etc.). It should be noted that this component's power-up state can disallow power flow from the power cord 42A to internal power system 50. The processing components must command the power control 48 to allow power to flow.

Ethernet over power line network interface component 54 and the Ethernet to AC Power Converter (not shown)—these features allow standard Ethernet protocol to flow over a power line.

AC/DC power converter 56—this component provides power to electrical device 30 and is energized immediately when the power cord 42 is connected to the power socket 40.

(Optional) Location component/function 34—as indicated above, this component provides the location of electrical device 30 based on the location of power bar 45 (e.g., physical location such as office “Y”) to identification component 36 (e.g., in response to a query received by identification component 36 from authentication component 38).

Identification component 36—provides the identity of electrical device 30 (e.g., printer XYZ), as well as the location thereof as received from location component 34 for electrical device 30, to authentication component 38 (e.g., in response to a query received by identification component 36 from authentication component 38). This information can be obtained from a static source such as an embedded chip, an RFID tag, etc. It can also be obtained from a file or the like. Still yet, the identity can be obtained by interactively asking an operator to input the information via a display and buttons or the like positioned on power bar 45. Identification component 36 performs the supplicant function of the 802.1X standard.

Authentication component 38—provides the identity and the location to the authentication server, and receives the command to energize the electrical device 30. This component controls electrical device 30's power control 48. To this extent, authentication component 38 performs the authenticator function of the 802.1X standard.

It should be noted that some or all of the components can be combined into the same physical hardware. For example, identification component 36 and authentication component 38 could co-exist on the same physical processor. In addition, the authentication server is not shown, but should be understood to be attached to the power delivery network via an Ethernet over Power line connection. The authentication server then communicates with the authentication component 38 using IP protocols and 802.1X protocols.

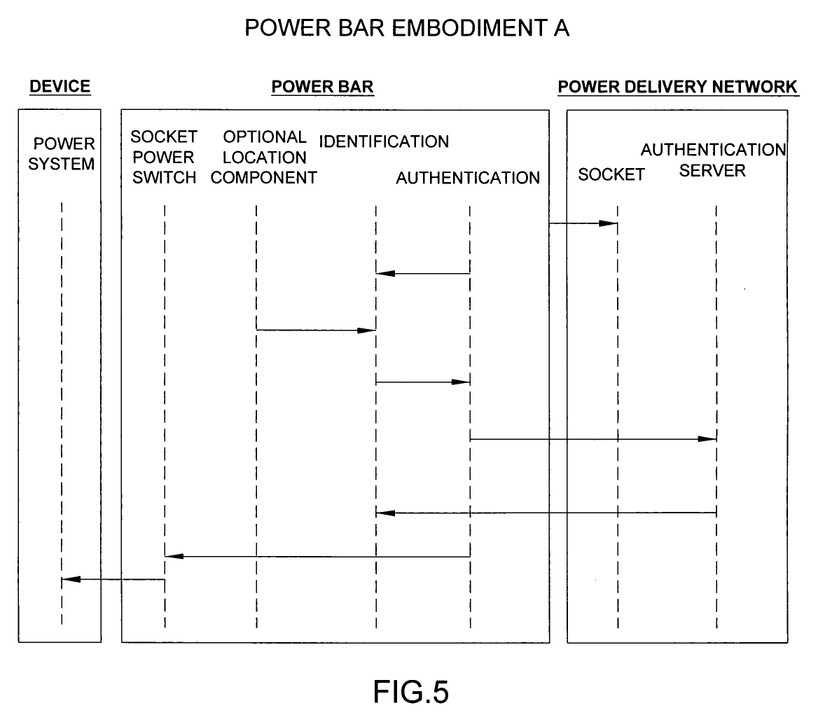

Referring to FIG. 5, an operation flow diagram of the embodiment of FIGS. 3A-B and 4 is shown and will be described in detail. Specifically, under this embodiment, the electrical device is connected to the power bar (via a power cord), and the power cord for the power bar is connected to a power socket. Then, the authentication component in the power bar challenges the identification component to authenticate the device. This can typically occur via a query generated by and sent from the authentication component to the identification component. In response to the query, the optional location component can provide the location of the power bar (and hence the electrical device) (e.g., a first attribute) to the identification component. In addition, (also in response to the query) the identification component will provide the location (if received) and the identity of the electrical device (e.g., a second attribute of the electrical device) to the authentication component. Collectively, the identity and location are referred to herein as authentication information.

In any event, the authentication component will then provide this authentication information to the authentication server, which will attempt to authenticate the device. To this extent, authentication (and subsequent activation) of the electrical device can be based on the identity of electrical device as well its physical location. This allows the power to the device to be managed/controlled based on any number of considerations such as the device's relative importance, power availability, the device's location (e.g., anti-theft), the device's previous workload, the device's calibration status, etc.

Regardless, upon successful authentication of the electrical device, the authentication component will command the power switch for the power bar to be turned on, thus activating the electrical device. When the power cord is removed, the power switch inside the power bar will be deactivated. Although not shown in FIG. 5, the authentication server will also store the results of the authentication process in the device information database. It can further associate the electrical device with other information and create corresponding fields in the device information database.

Under the present invention, if authentication server determines that the electrical device should be disabled (e.g., due to power shortages, floods or other disasters, theft, etc.), authentication server will send an instruction to the like to authentication component. Based on the instruction, power bar will disable (i.e., turn of the power to) electrical device 30.

### Power Bar Embodiment B

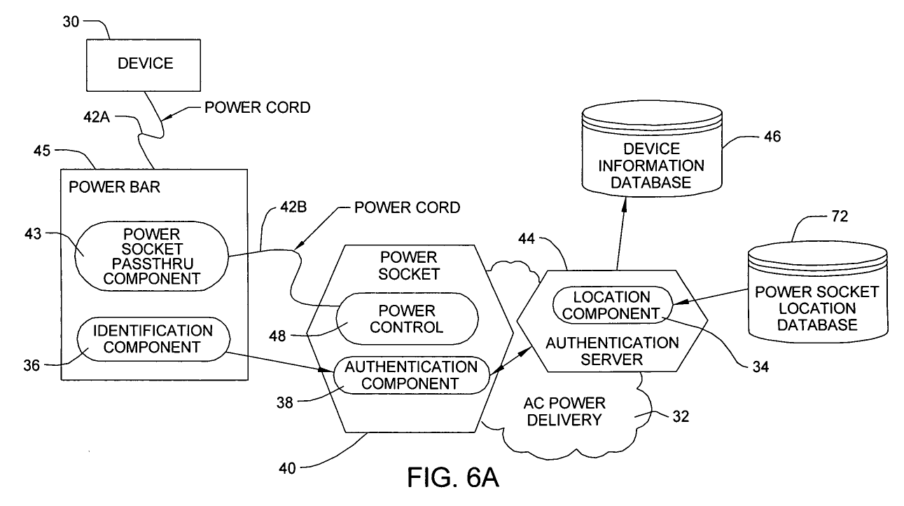

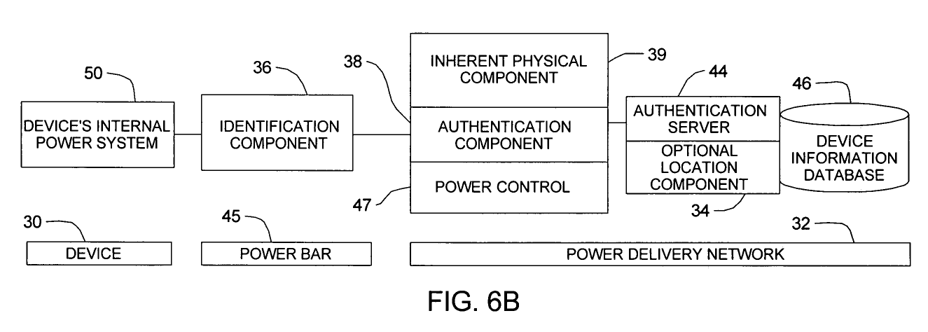

Referring now to FIG. 6A, another embodiment for managing an electric device 30 over (AC) power delivery network 32 according to the present invention is shown. In the embodiment shown in FIG. 6A, identification component 36 remains contained within power bar 45. However, authentication component 38 is now contained within power socket 40 of power delivery network 32 while optional location component 34 is located on authentication server 44. As will be further described below, the location of electrical device 30 will be determined in this embodiment based on the location of power socket 40. Specifically, authentication component 38 will provide an attribute of power socket 40 such as its identity to authentication server 44. Using this information, optional location component 34 on authentication server 44 can determine the physical location of power socket 40 by referencing power socket location database 72, which associates power socket identifications (or other attributes of power socket 40) with their physical locations. Since electrical device 30 is connected to power socket 40 via power cord 42 of finite length, it is presumed that electrical device 30 is generally in the same physical location as power socket 40.

Similar to the first embodiment discussed above, identification component 36 will be queried or challenged by authentication component 38 to provide authentication information corresponding to electrical device 30. In response to the query, identification component 36 will provide an attribute of electrical device 30 (e.g., the identity of electrical device 30) to authentication component 38, which will then provide the attribute of electrical device 30, as well an attribute of power socket 40 (e.g., the identity of power socket 40), to authentication server 44. Authentication server 44 will then authenticate electrical device 30 using the information. Specifically, using the identification of electrical device 30, and the physical location of power socket 40 (e.g., as determined based on the identification of power socket 40 by cross-referencing power socket location database 72), authentication server 44 can attempt to authenticate electrical device 30. If successful, electrical device can be activated (e.g., power can be supplied thereto). It should be understood that other than the physical placement and functional differences discussed herein, the features/components of FIG. 6A will generally have the same functions as set forth above in conjunction with FIG. 3A.

Referring now to FIG. 6B, physical and logical views of the embodiment of FIG. 6A are shown. Specifically, as shown, electrical device 30 includes internal power system 50, while power bar 45 includes identification component 36. Power delivery network 32 includes optional location component 34, inherent physical component function 39, authentication component 38, power control 48, authentication server 44 and devices information database 46. Although not shown, power delivery network 32 will also contain power socket database 72.

FIG. 7 depicts a more detailed diagram the embodiment of FIGS. 6A-B of the present invention. As depicted, electrical device 30 includes internal power system 50 and is connected to power bar 45 via power cord 42A. Power bar 45 includes power bar socket 51, identification component 36, Ethernet to AC power coupler 52, and Ethernet over power line network interface component 54. As further shown, power socket 40 includes power socket power control (AC power switch) 49, Ethernet to AC power coupler 52, Ethernet over power line network interface component 54, and authentication component 38. As indicated above, location component 34 is contained on authentication server (not shown). Similar to FIGS. 6A-B in relation to FIGS. 3A-B, the features/components of FIG. 7 generally have the same functions as their counterparts in FIG. 4 (excepting any distinctions pointed out herein). For example, power switch 49 is located in power socket 40 in FIG. 7, as opposed to in power bar 45 as shown in FIG. 4. In FIG. 7, power switch 49 is the component, which under control of the 802.1X authentication component 38, connects the power cord 42B to the AC power delivery network. Multiple different physical components could be used, e.g., FETs, relays, digital or analog control signals to the power socket's AC/DC power switch, etc. Note that this component's power up state allows power flow from the AC power delivery network to the power bar 45's power cord 42B. The processing components must command the component to allow power to flow.

It should be noted that some or all of the components can be combined into the same physical hardware. For example, identification component 36 and authentication component 38 could co-exist on the same physical processor. In addition, the authentication server is not shown, but should be understood to be attached to the power delivery network via an Ethernet over Power line connection. The authentication server then communicates with the authentication component 38 using IP protocols and 802.1X protocols.

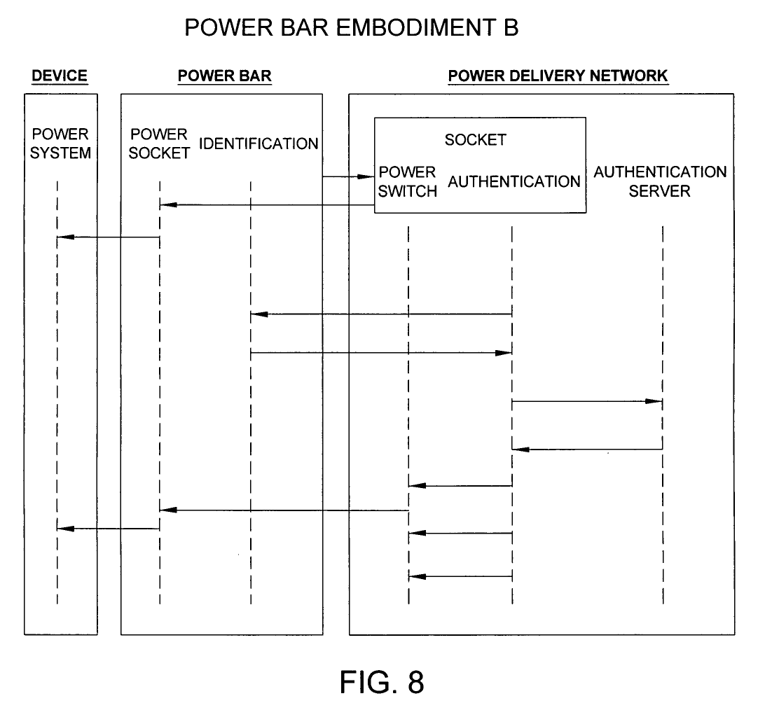

Referring to FIG. 8, an operation flow diagram of the embodiment of FIGS. 6A-B and 7 is shown and will be described in detail. Specifically, under this embodiment, when the power cord for the electrical device is connected to the power bar, and the power cord for the power bar is connected to a power socket, power is initially allowed to flow through the power socket. Then, the authentication component in the power socket will challenge the identification component in the power bar to authenticate the device. This can typically occur via a query generated by and sent from the authentication component to the identification component. In response to the query, the identification component in the power bar will provide an attribute (e.g., the identity) of the electrical device to the authentication component. The authentication component in the power socket will provide this information, along with an attribute (e.g., the identity) of the power socket to the authentication server.

The authentication server will then attempt to authenticate the electrical device using these pieces of information. As indicated above, the location of the power socket can be determined by the location component contained on the authentication server using the power socket's identity by cross-referencing the power socket location database. To this extent, the power socket location database will typically associate the location of power sockets with other attributes thereof such as their identities. In any event, given the information, such as the identity of the electrical device and the physical location of the power socket (and the power bar and electrical device), authentication of the electrical device based thereon can be attempted. Similar to the embodiment of FIGS. 3A-B, this allows the power to the device to be enabled/disabled based on any number of considerations such as the device's relative importance, power availability, the device's location (e.g., anti-theft), the device's previous workload, the device's calibration status, etc. Upon successful authentication of the electrical device, the authentication component will keep the power switch in the power socket “on”. If the authentication fails, the authentication component will turn the power switch in the power socket “off”, and the electrical device will lose power. When the power cord is removed, the power switch inside the electrical device will be activated so that subsequent use of the power socket is enabled. Note that this reactivation of the power socket can be based on a delay if required. Similar to Embodiment A discussed above, if the authentication server determines that the electrical device should be disabled (e.g., due to power shortages, floods or other disasters, theft, etc.), authentication server will send an instruction to the like to authentication component in power socket. Based on the instruction, authentication component will disable (i.e., turn of the power to) power bar 45 (and hence to electrical device 30).

Although not shown in FIG. 8, the authentication server will also store the results of the authentication process in the device information database. It can further associate the electrical device with other information and create corresponding fields in the device information database. Regardless of the embodiment implemented, the present invention results in (among other things) a standard-based database of information about the electrical device(s) that is attached to the power network. Specifically, the device information database, is typically located on the authentication server, and contains records which link the identity of an electrical device with its location and its characteristics. This information enables multiple services to be created that use this information. Shown below is an illustration of a devices information database:

| | | Power | | | |
|---|---|---|---|---|---|
| | Power | Bar | Power- | | |
| | Bar | Socket | Bar | Power- | |
| Device_ID | ID | Number | Location | Bar's_Power_Socket_Location | Time_Device_was_energized |
| 1297 | PB- | 1 | F1- | P1A- | 07:42:15- |
| A098CB | 1289401 | | 1345/ | 5-1- | Feb 22- |
| | | | RTP | DD006/ | 2005 |
| | | | | 660/ | |
| | | | | RTP | |
| 8391032 | PB- | 5 | F4- | P3B- | 09:14:10- |
| WW97 | 4892004 | | 4200/ | 8-2- | Feb 22- |
| | | | RTP | FF004/ | 2005 |
| | | | | 660/ | |
| | | | | RTP | |
| Printer- | PG- | 2 | F3- | P94-5- | 09:42:10- |
| 04 | 3897209 | | 1202/ | 1- | Aug 05- |
| | | | RTP | GG000/ | 2004 |
| | | | | 660/ | |
| | | | | RTP | |
| 1297 | PB- | 2 | F5- | L1A- | 10:12:15- |
| A098CB | 4892007 | | 4221/ | 2-1- | Feb 23- |
| | | | RTP | EE006/ | 2005 |
| | | | | 660/ | |
| | | | | RTP | |
| Printer- | PG- | 4 | F3- | P84-5- | 09:42:10- |
| 02 | 3897211 | | 1206/ | 1- | Mar 20- |
| | | | RTP | GG004/ | 2004 |
| | | | | 660/ | |
| | | | | RTP | |

| | Time_Device_was_de- | | | |
|---|---|---|---|---|
| Device_ID | energized | Device's_Power_Consumption | Device_Power_Priority | etc. |
| 1297 | 16:04:02- | 0.4 | 1 | other |
| A098CB | Feb 22- | | | |
| | 2005 | | | |
| 8391032 | -Still on- | 0.5 | 1 | other |
| WW97 | | | | |
| Printer- | -Still on- | 6.8 | 3 | other |
| 04 | | | | |
| 1297 | -Still on- | 0.7 | 1 | other |
| A098CB | | | | |
| Printer- | -Still on- | 4.2 | 3 | other |
| 02 | | | | |

In general, the present invention leverages information such that shown in the table above, to enable/disable an electrical device over the power delivery network using a power bar. For example, the present invention provides information useful for physical inventory tracking. That is, by consultation of the devices information database, one can locate the physical assets without the necessity of a physical audit. In addition, the present invention provides information useful for device calibration. Specifically, some electrical devices require periodic calibration. In environments in which the electrical device is mobile (e.g., an IV drug dispensing device in a hospital), the locating of the device to perform calibration is problematic. In addition, for usage based calibration requirements, the consultation of the device information database could be used to determine when a subject device required calibration.

Still yet, the present invention can provide macro power management. In particular, by data-mining the information in the devices information database, a power usage profile could be created by device, location, (e.g., floor, time of day, day of year, etc.). This information could then be used for global power management. The present invention can also provide micro power management. That is, the consultation of the device information database, could be used to determine if the device's power consumption would exceed the capacity of the power delivery system or in management of the power delivery system. In addition, the present invention can provide theft deterrence. Specifically, if the electrical device's identification component, or also known as supplicant (IEEE 802.1x taxonomy), was configured to require authorization from the authentication server, prior to enabling power to flow to the electrical device, the electrical device would fail to energize without this function. An example of this could be TVs used in a hotel or hospital, in which, if stolen and plugged into a home power source would fail to authenticate and thus would not power up.

While shown and described herein as a method and system for enabling/disabling an electrical device over a power delivery network, it is understood that the invention further provides various alternative embodiments. For example, in one embodiment, the invention provides a program product stored on a computer-readable/useable medium that includes computer program code to enable the teachings of the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, (e.g., a fixed disk, a read-only memory, a random access memory, a cache memory, and/or the like).

In another embodiment, the invention provides a business method that performs the process steps of the invention on a subscription, advertising, and/or fee basis. That is, a service provider, such as a Solution Integrator, could offer to enable/disable electrical devices over a power delivery network. In this case, the service provider can create, maintain, support, etc., one or more of the features described herein that performs the process steps of the invention for one or more customers. In return, the service provider can receive payment from the customer(s) under a subscription and/or fee agreement and/or the service provider can receive payment from the sale of advertising content to one or more third parties.

As used herein, it is understood that the terms “program code” and “computer program code” are synonymous and mean any expression, in any language, code or notation, of a set of instructions intended to cause a hardware state-machine device or computing device having an information processing capability to perform a particular component either directly or after either or both of the following: (a) conversion to another language, code or notation; and/or (b) reproduction in a different material form. To this extent, program code can be embodied as one or more hardware devices or an application/software program, component software/a library of components, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for disabling an electrical device, comprising:
a power bar associated with a power socket of a power delivery network, wherein the electrical device is connected to the power delivery network via the power bar; and
a first component for providing authentication information corresponding to the electrical device to an authentication server over the power delivery network, and for disabling the electrical device via the power bar in response to an instruction received from the authentication server.

2. The system of claim 1, wherein the first component is contained within the power bar.

3. The system of claim 1, wherein the first component is contained within the power socket.

4. The system of claim 1, further comprising:
a second component for providing an location for the power bar; and
a third identification component for providing an identity of electrical device, wherein authentication information comprises the location and the identity, and wherein the authentication information is used to authenticate and enable the electrical device.

5. The system of claim 4, wherein the second component and the third component are contained within the power bar.

6. The system of claim 4, wherein the second component is contained within the power socket, and wherein the third component is contained within the power bar.

7. The system of claim 1, further comprising a first database for storing information pertaining to the electrical device, the power bar, and the power socket.

8. The system of claim 7, wherein the first database further stores information pertaining to enablement and disablement of the electrical device.

9. The system of claim 7, further comprising a second database for storing a location of the power socket, wherein the location is associated with an identity of the power socket.

10. A system for disabling an electrical device, comprising:
a power bar associated with a power socket of a power delivery network, wherein the electrical device is connected to the power delivery network via the power bar;
means for providing an identity of the electrical device; and
means for receiving the identity from the identification component, for providing the identity to an authentication server over the power delivery network, and for disabling the electrical device via the power bar in response to an instruction received from the authentication server.

11. The system of claim 10, further comprising means for providing location of the power bar.

12. The system of claim 10, wherein the means for receiving is contained within the power bar.

13. A method for disabling an electrical device, comprising:
receiving an instruction to disable the electrical device in a first component from an authentication server over a power delivery network; and
disabling the electrical device in response to the instruction via a power bar that is connected to a power socket of the power delivery network and the electrical device.

14. The method of claim 13, further comprising:
accessing a database to identify and locate the electrical device; and
sending the instruction from the authentication server to the first component after the accessing.

15. The method of claim 13, further comprising:
providing authentication information for the electrical device from the first component to the authentication server over the power delivery network; and
enabling the electrical device via the power bar upon successful authentication of the electrical device.

16. The method of claim 13, wherein the electrical device is connected to the power delivery network via the power bar.

17. The method of claim 13, wherein the first component is contained within the power bar.

18. The method of claim 13, wherein the first component is contained within the power socket.

19. The method of claim 19, wherein the authentication information further comprises a location of the electrical device as provided by a second component.

20. The method of claim 13, wherein the authentication information comprises an identity of the electrical device as provided by an third component.
